(19) United States
(12) Patent Application Publication
(10) Pub. No.: US 2015/0188363 A1
(43) Pub. Date: Jul. 2, 2015

(54) ELECTRIC POWER TRANSMITTING APPARATUS CAPABLE OF PERFORMING WIRELESS POWER TRANSMISSION, CONTROLLING METHOD FOR ELECTRIC POWER TRANSMITTING APPARATUS, AND STORAGE MEDIUM

(71) Applicant: CANON KABUSHIKI KAISHA, Tokyo (JP)

(72) Inventor: Ryohei Yamada, Kawasaki-shi (JP)

(21) Appl. No.: 14/559,843

(22) Filed: Dec. 3, 2014

(30) Foreign Application Priority Data
Dec. 26, 2013 (JP) 2013-270441

(51) Int. Cl. H02J 17/00; H02J 5/00

(52) U.S. Cl. CPC H02J 17/00; H02J 5/005

(57) ABSTRACT

An electric power transmitting apparatus performing wireless power transmission to an electric receiving apparatus within a power supply area including: an identifying unit configured to identify a distance between the electric receiving apparatus and the electric power transmitting apparatus; and a changing unit configured to change the power supply area, based on the distance identified by the identifying unit.

### BACKGROUND OF THE INVENTION

1. Field of the Invention

The present invention relates to an electric power transmitting apparatus capable of performing wireless power transmission, a controlling method for the electric power transmitting apparatus, and a storage medium.

2. Description of the Related Art

There are four methods for contactlessly (wirelessly) supplying power. Specifically, they are an electromagnetic induction system, a magnetic field resonance system, an electric field coupling system and a radio wave reception system. Recently, attention is attracted on the magnetic field resonance system which enables both of sufficient power that can be transmitted and a long power transmission distance, among those four systems. In the magnetic field resonance system, a method of an electric power transmitting apparatus performing power transmission to a plurality of electric receiving apparatuses is proposed (for example, Japanese Patent Application Laid-Open No. 2009-136132).

In the technique described in Japanese Patent Application Laid-Open No. 2009-136132, an electric power transmitting apparatus dispatches predetermined pulse signals at the time of a standby mode in which the electric power transmitting apparatus does not supply power to search for whether an electric receiving apparatus has been positioned near within several meters. Then, when an electric receiving apparatus sends its own ID to the electric power transmitting apparatus, the electric power transmitting apparatus determines whether the electric receiving apparatus is a power-supply-target electric receiving apparatus or not. If the electric receiving apparatus is a power-supply-target electric receiving apparatus, the electric power transmitting apparatus transmits power to be supplied, to the electric receiving apparatus. At this time, since the electric power transmitting apparatus can transmit its own code to the electric receiving apparatus to be informed of an amount of charge, a state of the apparatus and the like from the electric receiving apparatus individually.

There is also proposed a technique in which a plurality of electric power transmitting apparatuses are combined to operate as one coupled system (for example, Japanese Patent Application Laid-Open No. 2011-211874).

In a wireless power transmission system, a power supply area is specified in which an electric power transmitting apparatus can supply power. However, when the laid-out power supply area is much larger than positions of electric receiving apparatuses, the electric power transmitting apparatus wastes power for that reason. When the power supply area is smaller than the positions of the electric receiving apparatuses, the electric power transmitting apparatus cannot supply power to the electric receiving apparatuses.

### SUMMARY OF THE INVENTION

Thus, an object of the present invention is to appropriately change a power supply area in a wireless power transmission system.

According to an aspect of the present invention, an electric power transmitting apparatus performing wireless power transmission to an electric receiving apparatus within a power supply area comprises: a identifying unit configured to identify a distance between the electric receiving apparatus and the electric power transmitting apparatus; and a changing unit configured to change the power supply area, based on the distance identified by the identifying unit.

Further features of the present invention will become apparent from the following description of exemplary embodiments with reference to the attached drawings.

### BRIEF DESCRIPTION OF THE DRAWINGS

FIG. 1 is a conceptual diagram illustrating an example of a configuration of a one-to-N wireless power transmission system.

FIG. 2 is a diagram illustrating an example of a hardware configuration of an electric power transmitting apparatus.

FIG. 3 is a diagram illustrating an example of a hardware configuration of an electric receiving apparatus.

FIG. 4 is a diagram illustrating an example of a control sequence of the whole one-to-N wireless power transmission system.

FIG. 5 is a flowchart (1) illustrating an example of a process of the electric power transmitting apparatus.

FIG. 6 is a flowchart (2) illustrating an example of a process of the electric power transmitting apparatus.

FIG. 7 is a flowchart (3) illustrating an example of a process by the electric power transmitting apparatus.

FIG. 8 is a diagram illustrating an example of a management table.

FIG. 9 is a diagram illustrating an example of change in a power supply area.

FIG. 10 is a flowchart (4) illustrating an example of a process of the electric power transmitting apparatus.

FIG. 11 is a flowchart (5) illustrating an example of a process by the electric power transmitting apparatus.

FIG. 12 is a diagram illustrating an example of a result of trial power supply.

FIG. 13 is a flowchart (6) illustrating an example of a process of the electric power transmitting apparatus.

FIG. 14 is a diagram illustrating an example of change in the power supply area in a case where the electric receiving apparatus has moved.

### DESCRIPTION OF THE EMBODIMENTS

Preferred embodiments of the present invention will now be described in detail in accordance with the accompanying drawings.

### First Embodiment

(Wireless Power Transmission System Configuration)

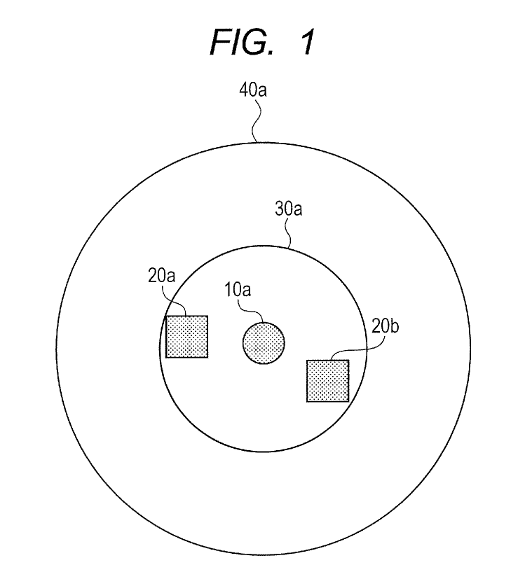

FIG. 1 is a conceptual diagram illustrating an example of a configuration of a one-to-N wireless power transmission system in which an electric power transmitting apparatus transmits power to a plurality of electric receiving apparatuses.

An electric power transmitting apparatus 10a wirelessly supplies power to each of electric receiving apparatuses 20a and 20b. The electric power transmitting apparatus 10a also performs data communication necessary for power supply with each of the electric receiving apparatuses 20a and 20b within a communicable range.

Each of the electric receiving apparatuses 20a and 20b wirelessly receives power supplied from the electric power transmitting apparatus 10a. Each of the electric receiving apparatuses 20a and 20b also performs data communication necessary for power supply with the electric power transmitting apparatus 10a within the communicable range.

A power supply area 30a indicates an area where power supply from the electric power transmitting apparatus 10a to each of the electric receiving apparatuses 20a and 20b can be performed.

A communication area 40a indicates an area where the electric power transmitting apparatus 10a can perform data communication. In the case of the example in FIG. 1, communication counterparts of the electric power transmitting apparatus 10a are the electric receiving apparatuses 20a and 20b.

In a configuration like that in FIG. 1, the electric power transmitting apparatus 10a changes a power supply area where power is supplied by wireless power transmission, by changing an output current according to a distance between each of the electric receiving apparatuses 20a and 20b in the communicable range and the electric power transmitting apparatus 10a itself (own apparatus), and thereby realizes energy saving.

(Electric Power Transmitting Apparatus Configuration)

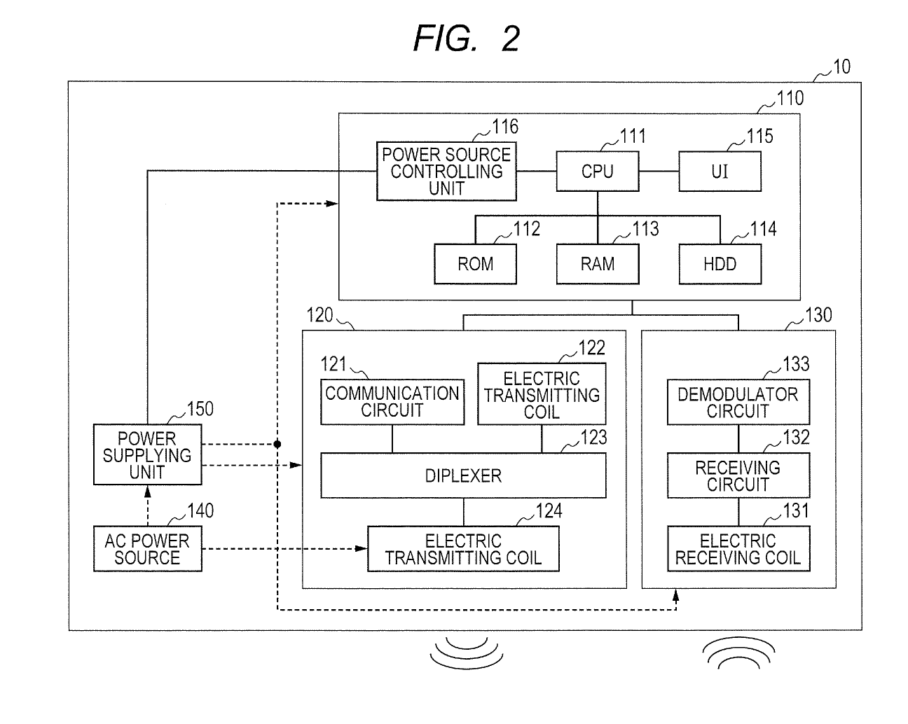

FIG. 2 is a diagram illustrating an example of a hardware configuration of an electric power transmitting apparatus. In FIG. 2, exchange of data is indicated by solid lines, and supply of power is indicated by dotted lines.

An electric power transmitting apparatus 10 includes a control section 110, a wireless transmission section 120, a wireless reception section 130, an AC power source 140 and a power supplying section 150.

The control section 110 controls the electric power transmitting apparatus 10. The control section 110 includes a CPU 111, a ROM 112, a RAM 113, an HDD 114, a UI 115 and a power source control section 116. The control section 110 is connected to the wireless transmission section 120 and the wireless reception section 130 via an internal bus.

The CPU 111 executes various kinds of processes to control the electric power transmitting apparatus 10. By executing programs stored in the ROM 112, the HDD 114 and the like, the CPU 111 realizes functions of the electric power transmitting apparatus 10, and a process of a sequence diagram and processes of flowcharts related to the electric power transmitting apparatus 10 to be described later.

The ROM 112 is a non-volatile storage medium and stores a boot program and the like used by the CPU 111. The RAM 113 is a volatile storage medium and temporarily stores data and programs used by the CPU 111, data to be exchanged at the time of exchanging information, and the like.

The HDD 114 is a non-volatile storage medium and stores an OS and applications used by the CPU 111, apparatus information which is not rewritten (a part of information management information), and the like. The UI 115 displays various information to a user and accepts various instructions from the user.

The power source control section 116 controls power supply to each unit.

The wireless transmission section 120 wirelessly transmits power to an electric receiving apparatus 20. The wireless transmission section 120 includes a communication circuit 121, an electric power transmitting circuit 122, a diplexer 123 and an electric power transmitting coil 124.

The communication circuit 121 generates a modulated signal for performing communication.

The electric power transmitting circuit 122 generates a modulated signal for transmitting power.

The diplexer 123 combines the modulated signal generated by the communication circuit 121 and the modulated signal generated by the electric power transmitting circuit 122.

The electric power transmitting coil 124 transmits the modulated signal combined by the diplexer 123 to the electric receiving apparatus 20.

The wireless reception section 130 receives data from the electric receiving apparatus 20. The wireless reception section 130 includes an electric receiving coil 131, a reception circuit 132 and a demodulator circuit 133.

The electric receiving coil 131 receives a modulated signal for performing communication, from the electric receiving apparatus 20.

The reception circuit 132 receives the modulated signal received by the electric receiving coil 131.

The demodulator circuit 133 demodulates the modulated signal received by the reception circuit 132.

The AC power source 140 supplies an AC voltage to the electric power transmitting coil 124 and the power supplying section 150.

The power supplying section 150 converts the AC voltage supplied by the AC power source 140 to a DC voltage and supplies the DC voltage to the control section 110, the wireless transmission section 120 and the wireless reception section 130.

(Electric Receiving Apparatus Configuration)

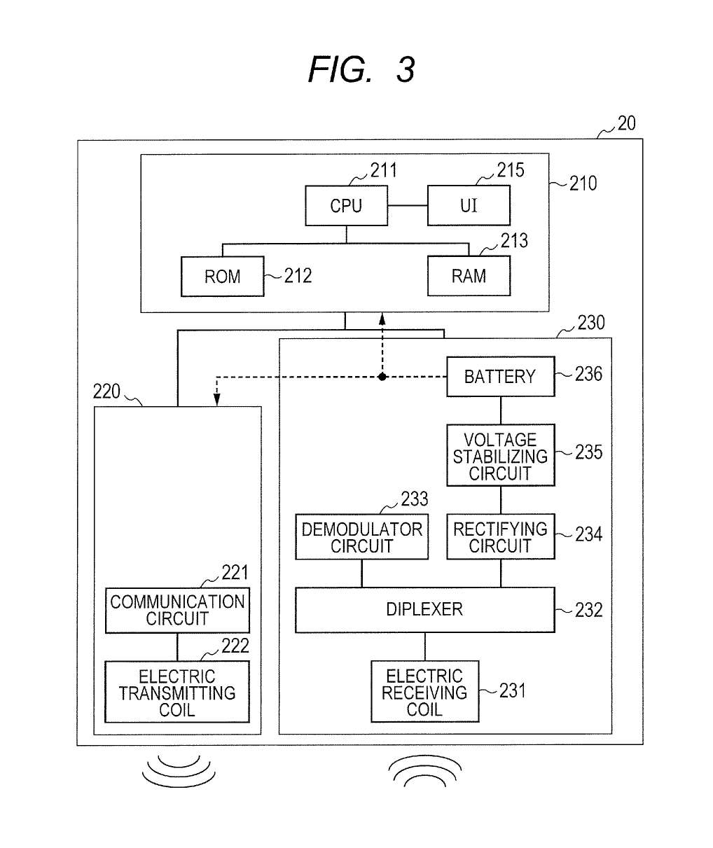

FIG. 3 is a diagram illustrating an example of a hardware configuration of an electric receiving apparatus. In FIG. 3, exchange of data is indicated by solid lines, and supply of power is indicated by dotted lines.

The electric receiving apparatus 20 includes a control section 210, a wireless transmission section 220 and a wireless reception section 230.

The control section 210 controls the electric receiving apparatus 20.

The control section 210 includes a CPU 211, a ROM 212, a RAM 213 and a UI 215. The control section 210 is connected to the wireless transmission section 220 and the wireless reception section 230 via an internal bus.

The CPU 211 executes various kinds of processes to control the electric receiving apparatus 20. By executing programs stored in the ROM 212 and the like, the CPU 211 realizes functions of the electric receiving apparatus 20, and a process of a sequence diagram related to the electric receiving apparatus 20 to be described later.

The ROM 212 is a non-volatile storage medium and stores a boot program and the like used by the CPU 211. The RAM 213 is a volatile storage medium and temporarily stores data, programs and the like used by the CPU 211.

The UI 215 displays various information to a user and accepts various instructions from the user.

The wireless transmission section 220 transmits data to the electric power transmitting apparatus 10. The wireless transmission section 220 includes a communication circuit 221 and an electric power transmitting coil 222.

The communication circuit 221 generates a modulated signal for performing communication.

The electric power transmitting coil 222 transmits the modulated signal generated by the communication circuit 221 to the electric receiving apparatus 10.

The wireless reception section 230 wirelessly receives power from the electric power transmitting apparatus 10. The wireless reception section 230 includes an electric receiving coil 231, a diplexer 232, a demodulator circuit 233, a rectifier circuit 234, a voltage stabilizing circuit 235 and a battery 236.

The electric receiving coil 231 receives a modulated signal from the electric power transmitting apparatus 10.

The diplexer 232 divides the modulated signal received by the electric receiving coil 231 into a modulated signal for performing communication and a modulated signal for transmitting power.

The demodulator circuit 233 demodulates the modulated signal for performing communication which has been divided by the diplexer 232.

The rectifier circuit 234 rectifies the modulated signal for transmitting power which has been divided by the diplexer 232 to generate a DC voltage.

The voltage stabilizing circuit 235 stabilizes the DC voltage generated by the rectifier circuit 234.

The battery 236 receives the voltage stabilized by the voltage stabilizing circuit 235 and accumulates power. The battery 236 also supplies a DC voltage to the control section 210, the wireless transmission section 220 and the wireless reception section 230 on the basis of the accumulated electric power.

(Control Sequence of Whole Wireless Power Transmission System)

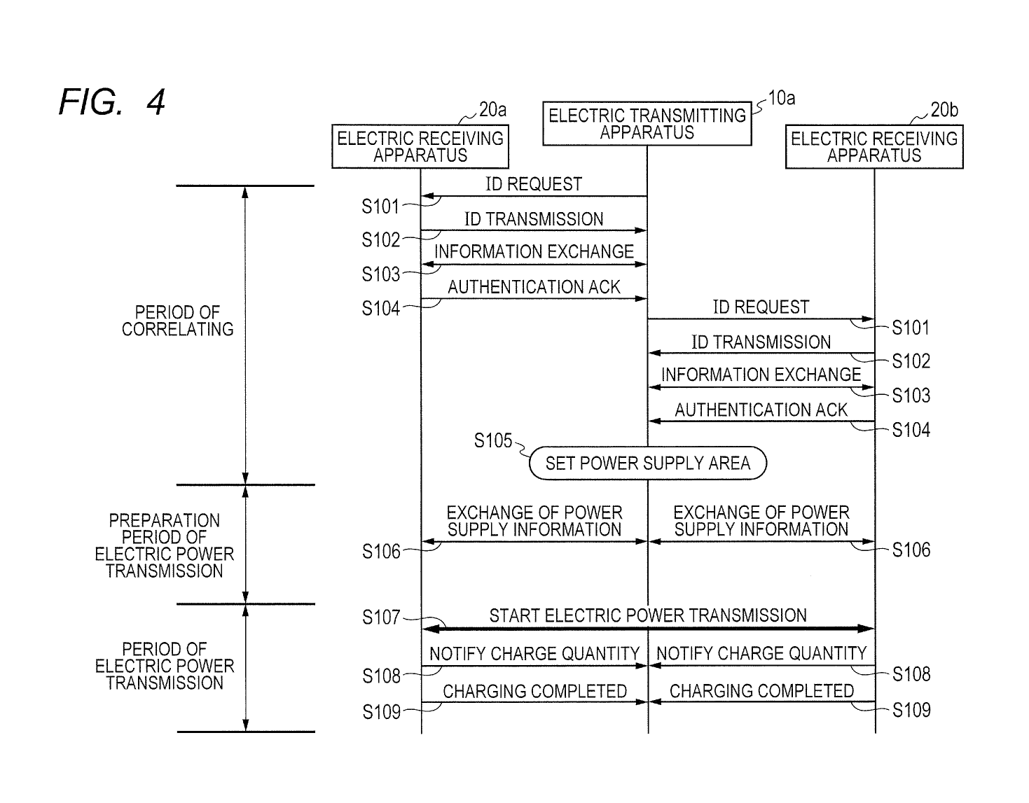

FIG. 4 is a diagram illustrating an example of a control sequence for the whole one-to-N wireless power transmission system. Data communication for 1-to-N wireless power transmission in which an electric power transmitting apparatus transmits power to a plurality of electric receiving apparatuses is realized by the following sequence. In the present embodiment, description will be made on a case where there are one communicable electric power transmitting apparatus and two electric receiving apparatuses which receive power supply. The number of electric power transmitting apparatuses and the number of electric receiving apparatuses are not limited thereto.

First, association between the electric power transmitting apparatus and the electric receiving apparatuses is performed.

The association between the electric power transmitting apparatus and the electric receiving apparatuses includes the following two steps. The first step is an authentication work for identifying whether or not an electric receiving apparatus exists in a communication area 40a of the electric power transmitting apparatus 10a. The second step is a work for, on the basis of a result of the authentication work for each electric receiving apparatus, determining the power supply area 30a where the electric power transmitting apparatus 10a supplies power to the electric receiving apparatus. Details of each step will be described below.

The authentication work between the electric power transmitting apparatus and the electric receiving apparatuses is performed for each electric receiving apparatus at S101 to S104. At S101, the electric power transmitting apparatus 10a issues a device ID request by broadcast to confirm whether an electric receiving apparatus exists in its own communication area 40a.

At S102, the electric receiving apparatuses 20a and 20b transmit device ID information to the electric power transmitting apparatus 10a which has issued the request.

At S103, each of the electric receiving apparatuses 20a and 20b confirms whether it is in the largest power supply area of the electric power transmitting apparatus 10a and exchanges information about a result thereof with the electric power transmitting apparatus 10a. The electric power transmitting apparatus 10a acquires a distance to each of the electric receiving apparatuses 20a and 20b from which the device IDs have been received, from a detection result of a position sensor at the timing of changing the information. The electric power transmitting apparatus 10a may determine whether or not the electric receiving apparatuses 20a and 20b are in the largest power supply area on the basis of a result of the electric power transmitting apparatus 10a performing power transmission training for the electric receiving apparatuses 20a and 20b or on the basis of the detection result of the position sensor.

When the electric power transmitting apparatus 10a ends information exchange with the electric receiving apparatuses 20a and 20b existing in its own communication area 40a, the electric receiving apparatuses 20a and 20b transmit authentication ACK (ACKnowledgement) to the electric power transmitting apparatus 10a at S104 and ends the authentication step.

Next, a step of the electric power transmitting apparatus 10a deciding the power supply area 30a will be described.

At S105, the electric power transmitting apparatus 10a sets an optimal power supply area 30a arranged on the basis of the distances to the electric receiving apparatuses 20a and 20b which can communicate with the electric power transmitting apparatus 10a, the distances having been acquired at S103. The optimal power supply area stated here means an area where the electric power transmitting apparatus 10a can supply power to the electric receiving apparatuses 20a and 20b most efficiently. The same goes in the description below. The association between the electric power transmitting apparatus and the electric receiving apparatuses ends through the process so far.

After the association period ends, a power transmission preparation period starts. In the power transmission preparation period, various kinds of settings for performing power transmission between the electric power transmitting apparatus and the electric receiving apparatuses are made. As examples of the various kinds of settings, settings of the device IDs of power supply destinations, the source ID of a power supply source, power supply frequency, remaining power information about the electric receiving apparatuses, and the like are given. Operations of the electric power transmitting apparatus 10a and the electric receiving apparatuses 20a and 20b during the power transmission preparation period will be described below.

At S106, the electric power transmitting apparatus 10a exchanges information necessary for supplying power with the electric receiving apparatuses 20a and 20b.

When the exchange of the power supply information ends between the electric power transmitting apparatus 10a and the electric receiving apparatuses 20a and 20b, the power transmission preparation period ends. At the next S107, a power transmission period starts.

At S107, the electric power transmitting apparatus 10a starts wireless power transmission to the electric receiving apparatuses 20a and 20b. During the wireless power transmission period, the electric receiving apparatuses 20a and 20b which are receiving power periodically notify the electric power transmitting apparatus 10a of the amount of charge at S108.

At S109, the electric receiving apparatuses 20a and 20b which have reached full charge notify the supply-source electric power transmitting apparatus 10a of completion of charge.

On the other hand, if the electric power transmitting apparatus 10a cannot receive the notification of the mount of charge for a reason that the electric receiving apparatuses 20a and 20b are powered off before completion of charge or a reason that they have moved outside the communication area, the electric power transmitting apparatus 10a ends power supply.

When the necessity of power supply is eliminated for the reason that both the electric receiving apparatuses 20a and 20b have completed charge or the reason that the electric power transmitting apparatus 10a cannot receive a notification of the amount of charge from the electric receiving apparatuses 20a and 20b, as described above, the power transmission period ends, and the electric power transmitting apparatus 10a proceeds to the association period again.

The above is the process related to the control sequence of the whole wireless power transmission system.

Next, contents of operations of the wireless power transmission system will be described with reference to flowcharts.

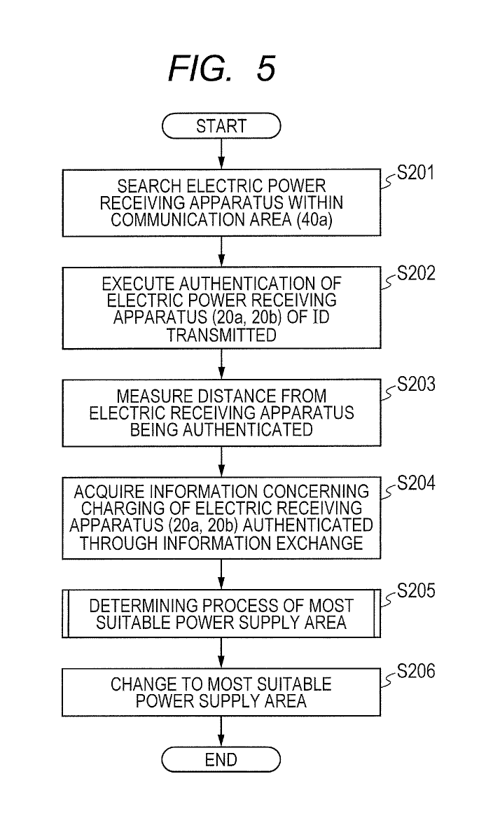

In the present embodiment, description will be made on a process in the case where the electric power transmitting apparatus 10 acquires information about charge of the electric receiving apparatuses and measures distances to the electric receiving apparatuses to set a power supply area with reference to flowcharts in FIGS. 5 to 7 and FIGS. 8 and 9.

FIG. 5 is a flowchart illustrating an example of a process of the electric power transmitting apparatus 10a in the present embodiment.

At S201, the electric power transmitting apparatus 10a issues a device ID request by broadcast to confirm (search for) whether an electric receiving apparatus exists in its own communication area 40a at an arbitrary timing, and starts association with the electric receiving apparatus.

At S202, the electric power transmitting apparatus 10a receives device IDs transmitted by the electric receiving apparatuses 20a and 20b which received the device ID request. Then, the electric power transmitting apparatus 10a starts an authentication work for the electric receiving apparatuses 20a and 20b having the received device IDs.

At S203, the electric power transmitting apparatus 10a detects positions of the electric receiving apparatuses 20a and 20b for which the authentication work is being performed to measure distances.

At S204, the electric power transmitting apparatus 10a acquires information about charge of the electric receiving apparatuses 20a and 20b. For example, the electric power transmitting apparatus 10a acquires information about optimal charge voltages in charging the electric receiving apparatuses 20a and 20b. The optimal charge voltages in charging the electric receiving apparatuses 20a and 20b are voltages determined in advance.

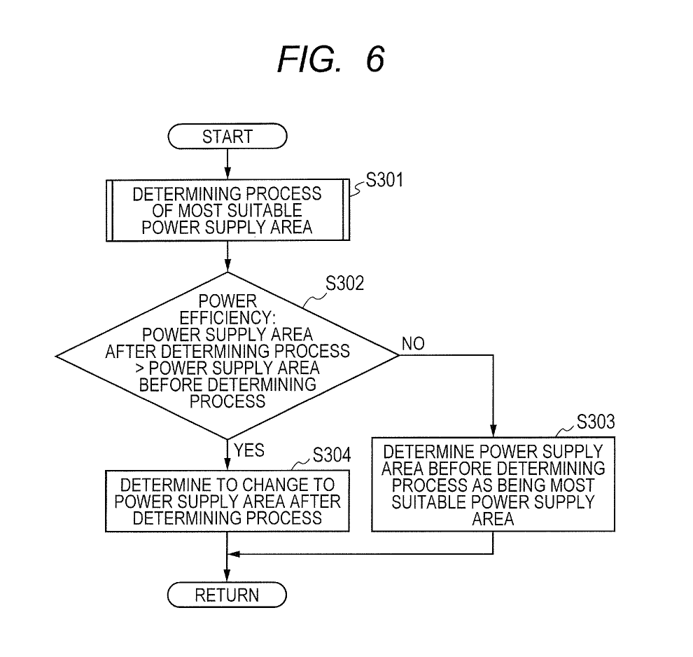

At S205, the electric power transmitting apparatus 10a determines an optimal power supply area on the basis of distance information showing the measured distances and the acquired charge voltage information. Details of the process of S205 will be described with reference to FIG. 6. When having executed a process in FIGS. 6 (S301 to S304), the electric power transmitting apparatus 10a transitions to S206.

FIG. 6 is a flowchart illustrating an example of an optimal power supply area determination process by the electric power transmitting apparatus 10a.

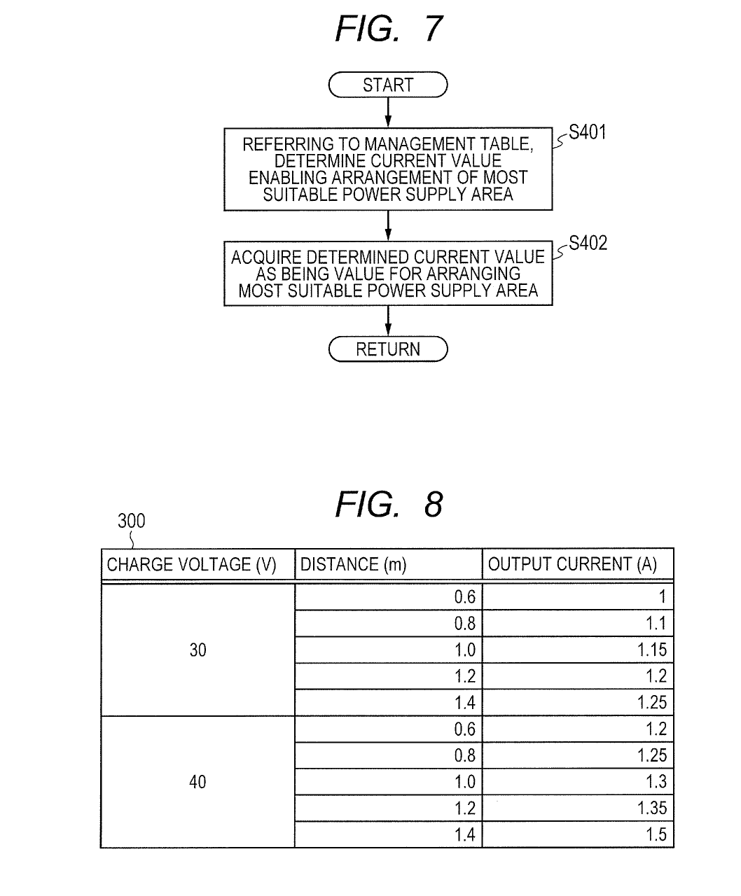

At S301, the electric power transmitting apparatus 10a performs an optimal power supply area decision process. More specifically, the electric power transmitting apparatus 10a determines a current value which enables arrangement of an optimal power supply area. Details of the process of S301 will be described with reference to FIG. 7.

FIG. 7 is a flowchart illustrating an example of the optimal power supply area decision process by the electric power transmitting apparatus 10a.

At S401, for example, at the time of supplying power to the electric receiving apparatuses 20a and 20b, the electric power transmitting apparatus 10a decides a current value which enables arrangement of an optimal power supply area, with reference to a management table 300 in FIG. 8. More specifically, the electric power transmitting apparatus 10a refers to the management table 300 in FIG. 8 on the basis of the distance information indicating the measured distances between the electric power transmitting apparatus 10a and the electric receiving apparatuses 20a and 20b and the acquired charge voltage information about the electric receiving apparatuses 20a and 20b. Then, the electric power transmitting apparatus 10a decides the smallest output current satisfying the charge voltages of the electric receiving apparatuses 20a and 20b.

The management table 300 is an example of management information in which a charge voltage, a distance and an output current are associated with one another. The charge voltage indicates a charge voltage of an electric receiving apparatus. The distance indicates a distance between an electric power transmitting apparatus and the electric receiving apparatus. The output current indicates a current the electric power transmitting apparatus 10a outputs. The output current which the electric power transmitting apparatus 10a outputs indicates a current value which enables the best power efficiency satisfying the charge voltage of the electric receiving apparatus for a distance between the electric power transmitting apparatus 10a and the electric receiving apparatus. Values related to the distance, the charge voltage and the output current are values set on the basis of a result of measurement performed by the electric power transmitting apparatus 10 in advance. For example, if the charge voltage indicated by acquired charge voltage information about an electric receiving apparatus is 30 V, and a distance to the electric receiving apparatus is 1.0 m, the electric power transmitting apparatus 10a refers to the management table 300 and decides the output current as 1.15 A.

At S402, the electric power transmitting apparatus 10a acquires the decided current value of the output current as a value which enables arrangement of an optimal power supply area. Thus, the electric power transmitting apparatus 10a can acquire an output current value for arranging an optimal power supply area by referring to the management table 300 on the basis of the distance information and the charge voltage information.

Now, we return to the description of FIG. 6. At S302, the electric power transmitting apparatus 10a compares the current value acquired in the decision process in FIGS. 7 (S401 and S402) and a current value before the decision process in FIG. 7 (an initial setting value, a value decided before or the like) to decide a current value which enables better power efficiency.

If the current value before the decision process enables better power efficiency as a result of the comparison at S302, the electric power transmitting apparatus 10a determines that the current value before the decision process enables arrangement of an optimal power supply area (S303). That is, the electric power transmitting apparatus 10a determines that the power supply area before the decision process to be the optimal power supply area.

If the current value acquired in the decision process enables better power efficiency as a result of the comparison at S302, the electric power transmitting apparatus 10a determines that the current value acquired in the decision process enables arrangement of an optimal power supply area (S304). That is, the electric power transmitting apparatus 10a determines that the power supply area is to be changed by changing the current value to the current value after the decision process.

Now, we return to the description of FIG. 5.

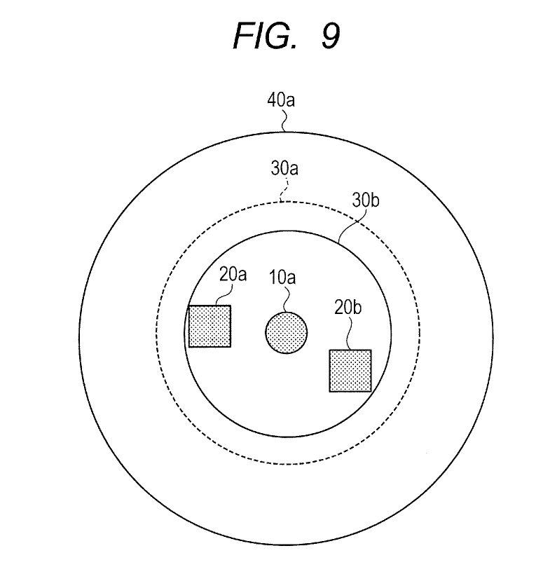

At S206, the electric power transmitting apparatus 10a reflects a result of the determination process (S301 to S304) and arranges the optimal power supply area. When the value of the current which the electric power transmitting apparatus 10a outputs is decreased, the power supply area is reduced. In this case, the electric power transmitting apparatus 10a changes the power supply area, for example, from the power supply area 30a to a power supply area 30b as in FIG. 9. As described above, the electric power transmitting apparatus 10a can change the arranged power supply area to an optimal power supply area.

As described above, according to the present embodiment, the electric power transmitting apparatus 10a can change the power supply area developed currently to an optimal power supply area by changing the value of an output current according to distances to electric receiving apparatuses and charge voltages. Thereby, the electric power transmitting apparatus 10a can realize energy-saving at the time of supplying power to electric receiving apparatuses by wireless power transmission.

### Second Embodiment

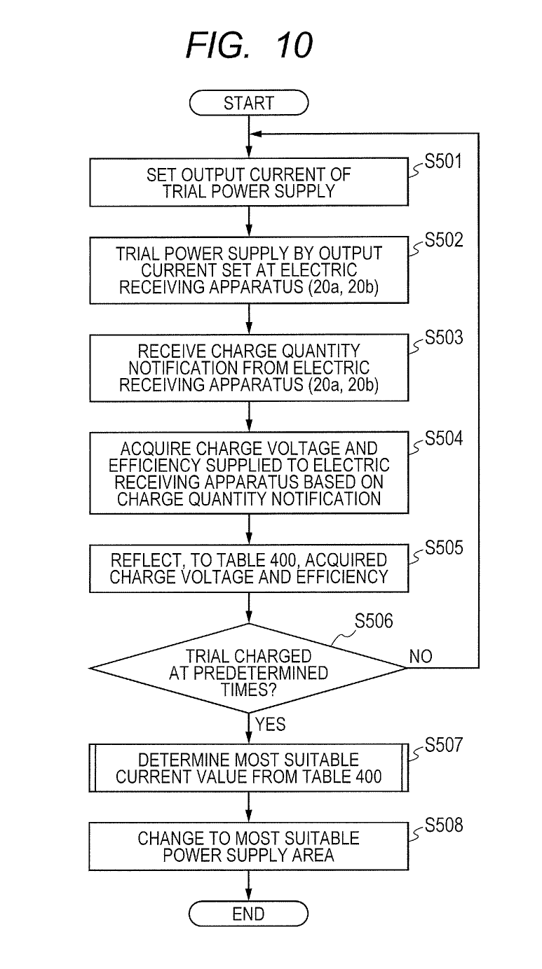

In the present embodiment, description will be made on a process in the case where the electric power transmitting apparatus 10a sets an optimal power supply area on the basis of a result of performing trial power supply to electric receiving apparatuses with reference to flowcharts in FIGS. 10 and 11 and FIG. 12. The present embodiment is an embodiment in the case where the electric power transmitting apparatus 10a and the electric receiving apparatuses 20a and 20b are in the power transmission period in FIG. 4.

FIG. 10 is a flowchart illustrating an example of a process of the electric power transmitting apparatus 10a in the present embodiment.

At S501, the electric power transmitting apparatus 10a sets an output current for trial power supply performed for the electric receiving apparatuses 20a and 20b. The electric power transmitting apparatus 10a uses an initial value set in advance first, and increments the value of the output current the next and subsequent times. The electric power transmitting apparatus 10a increments the value of the output current until trial power supply is performed a specified number of times. That is, the electric power transmitting apparatus 10a performs trial power supply while changing the value of a current to be output, from the initial value the specified number of times. The specified number of times may be changed by the electric power transmitting apparatus 10a or may be fixed.

At S502, the electric power transmitting apparatus 10a performs trial power supply to the electric receiving apparatuses 20a and 20b with the set output current.

At S503, the electric power transmitting apparatus 10a receives amount-of-charge notifications (with the same contents as the information which can be acquired at S108) from the electric receiving apparatuses 20a and 20b for which trial power supply has been performed.

At S504, the electric power transmitting apparatus 10a acquires charge voltages from the amount-of-charge notifications received from the electric receiving apparatuses 20a and 20b at S503, and calculates power efficiency using the value of its own output current.

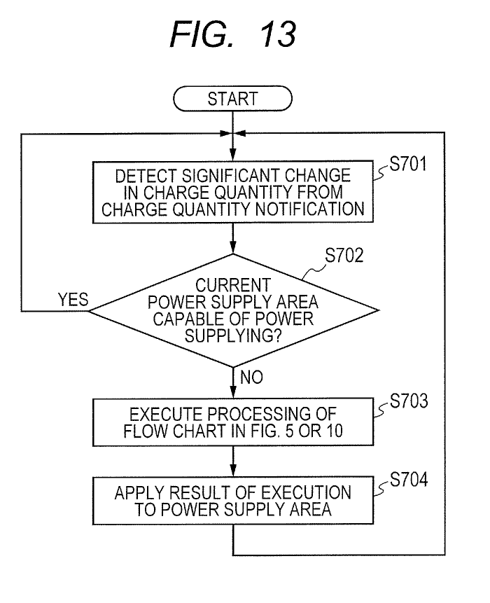

At S505, the electric power transmitting apparatus 10a reflects the charge voltages acquired at S504, the value of its own output current and the power efficiency on a table 400 in FIG. 12.

The table 400 is an example of a result of trial power supply (a trial result) showing a relationship among a charge voltage, an output current and efficiency. The charge voltage indicates a voltage with which the electric power transmitting apparatus 10a could supply power to an electric receiving apparatus. The output current indicates the output current of the electric power transmitting apparatus 10a when the electric power transmitting apparatus 10a supplied power to the electric receiving apparatus. The efficiency indicates what degree of efficiency the electric power transmitting apparatus 10a could supply power relative to power requested by the electric receiving apparatus. The electric power transmitting apparatus 10a determines the efficiency from power the electric power transmitting apparatus 10a supplied and power the electric receiving apparatus received. Here, the electric power transmitting apparatus 10a determines the power the electric power transmitting apparatus 10a supplied (power of the electric power transmitting apparatus) from an output current and an output voltage. The electric power transmitting apparatus 10a determines the power of the electric receiving apparatus from a charge voltage and a current which occurred at the time of charging. Then, the electric power transmitting apparatus 10a may derive the efficiency by an equation as shown below on the basis of the determined power.

power of electric power transmitting apparatus=output voltage×output current

power of electric receiving apparatuses=charge voltage×current which occurred at the time of charging efficiency=power of electric receiving apparatus/power of electric power transmitting apparatus

At S506, the electric power transmitting apparatus 10a confirms whether trial power supply has been performed the specified number of times. If trial power supply has not been performed the specified number of times, the electric power transmitting apparatus 10a transitions to S501. If trial power supply has been performed the specified number of times, the electric power transmitting apparatus 10a transitions to S507.

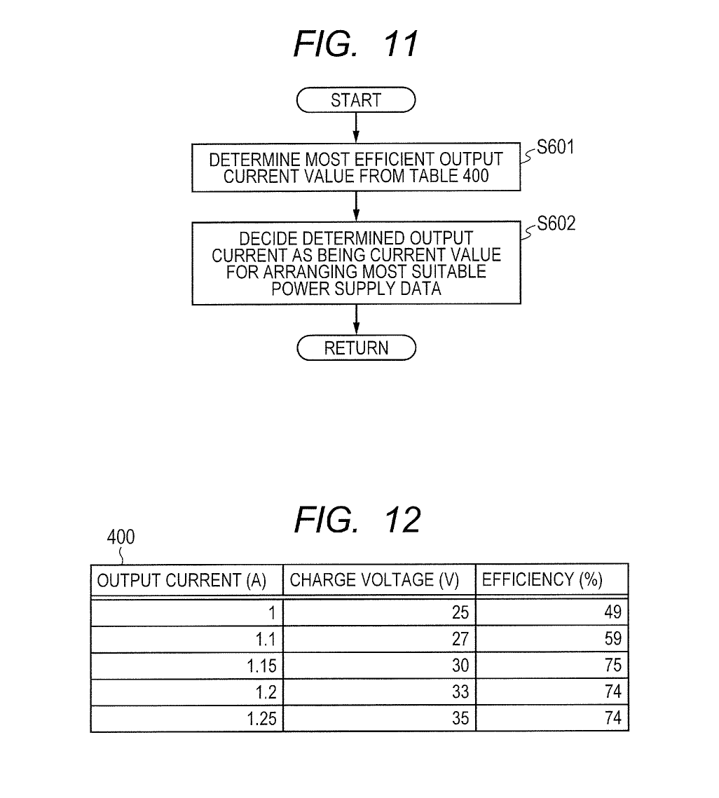

At S507, the electric power transmitting apparatus 10a decides an optimal current value from the table 400. Details of the process of S507 will be described with reference to FIG. 11.

FIG. 11 is a flowchart illustrating an example of an optimal output current decision process by the electric power transmitting apparatus 10a.

At S601, the electric power transmitting apparatus 10a searches for and decides an optimal current value which enables the best efficiency from the table 400.

At S602, the electric power transmitting apparatus 10a determines the output current decided at S601 as an output current which enables arrangement an optimal power supply area. Thereby, the electric power transmitting apparatus 10a can select and decide an output current which enables the best power efficiency (power supply efficiency).

Now, we return to the description of FIG. 10.

At S508, the electric power transmitting apparatus 10a reflects a result of the decision process (S601 and S602) and changes the power supply area. That is, the electric power transmitting apparatus 10a changes the power supply area to a power supply area corresponding to the output current decided by the decision process. Thereby, in the case of supplying power to the electric receiving apparatuses by wireless power transmission, the electric power transmitting apparatus 10a can change the power supply area to a power supply area which enables the best power efficiency.

As described above, according to the present embodiment, the electric power transmitting apparatus 10a can calculate efficiency in power supply to electric receiving apparatuses on the basis of a trial power supply result and decide an output current enabling power supply with the best efficiency, from a result of the calculation. That is, the electric power transmitting apparatus 10a can change the power supply area to an optimal power supply area on the basis of a result of trial power supply performed a specified number of times. Thereby, the electric power transmitting apparatus 10a can realize energy-saving at the time of supplying power to electric receiving apparatuses by wireless power transmission.

### Third Embodiment

In the present embodiment, description will be made on a process of the electric power transmitting apparatus 10a in the case where an electric receiving apparatus moves during power supply with reference to the flowcharts in FIGS. 5, 10 and 13 and FIG. 14. Since the processes of the flowcharts in FIGS. 5 and 10 have been described above, description thereof will be omitted.

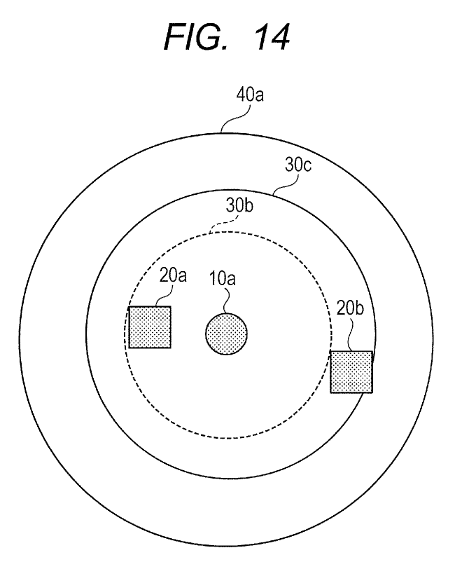

At S701, the electric power transmitting apparatus 10a detects that the amount of charge shown by an amount-of-charge notification periodically received from an electric receiving apparatus has significantly changed. Here, the phrase of “has significantly changed” means that, for example, a case where the degree of instability of magnetic flux density has exceeded a threshold. The case is a case where the degree of instability of change in efficiency of power supply from the electric power transmitting apparatus 10a to the electric receiving apparatus has exceeded a threshold, and it indicates that the distance between the electric power transmitting apparatus 10a and the electric receiving apparatus 20a or 20b has changed. For example, a case where the electric receiving apparatus 20b which existed in the power supply area 30b has moved to the outside of the power supply area 30b as illustrated in FIG. 14 is given an example.

At S702, the electric power transmitting apparatus 10a determines whether it is possible to supply power to the electric receiving apparatuses 20a and 20b which have transmitted the amount-of-charge notifications at S108, in the current power supply area. Here, the electric power transmitting apparatus 10a determines whether it is possible to supply power to the electric receiving apparatuses 20a and 20b in the current power supply area by having the electric receiving apparatuses 20a and 20b transmit amount-of-charge notifications again. If determining that power supply is impossible, the electric power transmitting apparatus 10a transitions to S703. If determining that power supply is possible, the electric power transmitting apparatus 10a exits the process of this flowchart.

At S703, the electric power transmitting apparatus 10a executes the process of the flowchart in FIG. or FIG. 10 described above to acquire a current value which enables arrangement of an optimal power supply area.

At S704, the electric power transmitting apparatus 10a reflects a result of the above execution on the power supply area. More specifically, the electric power transmitting apparatus 10a determines that the current value acquired at S703 is a current value which enables arrangement of an optimal power supply area and changes the power supply area according to the current value. For example, the electric power transmitting apparatus 10a extends the power supply area 30b in FIG. 14 to a power supply area 30c by changing the value of a current to be output. Thereby, even in the case where an electric receiving apparatus moves during power supply, the electric power transmitting apparatus 10a can detect the movement and change the power supply area to an optimal power supply area according to the movement.

The process of the electric power transmitting apparatus 10a in the case where an electric receiving apparatus has moved has been described above. Even in the case where a new electric receiving apparatus appears in the communication area 40a during power supply, the electric power transmitting apparatus 10a can change the power supply area to an optimal power supply area by a similar process. For example, when detecting that a new electric receiving apparatus has appeared in the communication area 40a during power supply, the electric power transmitting apparatus 10a executes the process in FIG. 5 or FIG. 10 again. Thereby, the electric power transmitting apparatus 10a can change the power supply area to an optimal power supply area in the case of including the new electric receiving apparatus which has appeared in the communication area 40a.

As described above, according to the present embodiment, even in the case where an electric receiving apparatus moves during power supply or in the case where a new electric receiving apparatus appears in a communication area, the electric power transmitting apparatus 10a can change an optimal power supply area again according to the change. Thereby, the electric power transmitting apparatus 10a can realize energy-saving at the time of supplying power to electric receiving apparatuses by wireless power transmission.

### Another Embodiment

The present invention can be realized by executing the following process. That is, the process is a process in which software (a program) which realizes the functions of the embodiments described above is provided to a system or an apparatus via a network or various kinds of storage media, and a computer (or a CPU, an MPU or the like) of the system or the apparatus reads and executes the program.

As described above, according to each of the above embodiments, it is possible to realize energy-saving at the time of an electric power transmitting apparatus supplying power to electric receiving apparatuses by wireless power transmission.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blue-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-270441, filed Dec. 26, 2013, which is hereby incorporated by reference herein in its entirety.

What is claimed is:

1. An electric power transmitting apparatus performing wireless power transmission to an electric receiving apparatus within a power supply area comprising:
a identifying unit configured to identify a distance between the electric receiving apparatus and the electric power transmitting apparatus; and
a changing unit configured to change the power supply area, based on the distance identified by the identifying unit.

2. The electric power transmitting apparatus according to claim 1, wherein
the changing unit changes the power supply area by changing an output current of the wireless power transmission.

3. The electric power transmitting apparatus according to claim 1, further comprising
a determination unit configured to determine as to whether the electric receiving apparatus moved or not, wherein,
when the determination unit determines such that the electric receiving apparatus moved, the changing unit changes the power supply area, based on the distance after the moving.

4. The electric power transmitting apparatus according to claim 3, further comprising
a receiving unit configured to receive information for identifying a power supply efficiency from the electric receiving apparatus, wherein,
when a changing of the power supply efficiency is larger than a predetermined threshold, the determination unit determines such that the electric receiving apparatus moved.

5. The electric power transmitting apparatus according to claim 1, further comprising
a detecting unit configured to detect an appearing a new electric receiving apparatus in a communicating area in which the electric power transmitting apparatus is capable of communicating, wherein
the identifying unit identifies the distance between the new electric receiving apparatus and the electric power transmitting apparatus, and
the changing unit changes the power supply area, based on the distance between the new electric receiving apparatus and the electric power transmitting apparatus, identified by the identifying unit.

6. A controlling method of an electric power transmitting apparatus performing wireless power transmission to an electric receiving apparatus within a power supply area comprising:
identifying a distance between the electric receiving apparatus and the electric power transmitting apparatus; and
changing the power supply area, based on the distance identified by the identifying.

7. A non-transitory computer-readable recording medium storing a readable program for operating a computer to execute a controlling method according to claim 6.
